(19) United States
(12) Patent Application Publication
(10) Pub. No.: US 2016/0371219 A1
(43) Pub. Date: Dec. 22, 2016

(54) EYEGLASS DOCKING STATION FOR A WEARABLE DISPLAY DEVICE

(71) Applicant: Vufine Inc., Sunnyvale, CA (US)

(72) Inventors: Douglas H. Lee, Sunnyvale, CA (US); Brendan E. Pierce, Sunnyvale, CA (US)

(21) Appl. No.: 15/184,030

(22) Filed: Jun. 16, 2016

Related U.S. Application Data
(60) Provisional application No. 62/181,678, filed on Jun. 18, 2015.

(51) Int. Cl. G06F 13/40; G02B 27/01; G02C 11/00; H04B 1/3827; G06F 1/16

(52) U.S. Cl. CPC G06F 13/4081; H04B 1/385; G06F 1/163; G02C 11/10; G02B 27/0176; G02B 27/0179; H04B 2001/3866; G02B 2027/0178

(57) ABSTRACT

A eyeglass docking station, comprising: a docking station body having a plurality of sides, wherein a first side includes a pocket formed in the docking station body, and a second side includes a fastener that attaches the docking station to a frame of the eyeglasses; and a docking pivot magnet housed within the docking station body positioned coaxial with the circular pocket, the circular pocket removably receiving a magnetized extrusion of a wearable display device to attach the wearable display device to the docking station body and to form a pivot point that allows a user to adjust a viewing angle of the wearable display device.

### CROSS-REFERENCE TO RELATED APPLICATION

This application claims the benefit of U.S. Provisional Patent Application Ser. No. 62/181,678, filed Jun. 18, 2015, assigned to the assignee of the present application and incorporated herein by reference.

### BRIEF SUMMARY

Exemplary embodiments provide methods and systems for a removable eyeglass docking station for a wearable display device. Aspects of exemplary embodiment include a docking station body having a plurality of sides, wherein a first side includes a pocket formed in the docking station body, and a second side includes a fastener that attaches the docking station to a frame of the eyeglasses; and a docking pivot magnet housed within the docking station body positioned coaxial with the circular pocket, the circular pocket removably receiving a magnetized extrusion of a wearable display device to attach the wearable display device to the docking station body and to form a pivot point that allows a user to adjust a viewing angle of the wearable display device. In one embodiment, the fastener includes a spring clip, and in another embodiment, the fastener includes a flexible band and a latch.

### BRIEF DESCRIPTION OF SEVERAL VIEWS OF THE DRAWINGS

FIG. 1 is a front perspective view of a eyeglass docking station.

FIG. 2 is a back perspective view of the eyeglass docking station in FIG. 1.

FIG. 3 is a transparent front perspective view of the eyeglass docking station in FIG. 1.

FIG. 4 is a back perspective view of the eyeglass docking station in FIG. 1 with foam backing removed.

FIG. 5 is an exploded view of the eyeglass docking station in FIG. 1.

FIG. 6 is a right-side perspective view of a wearable display device.

FIG. 7 is a left-side perspective view of the wearable display device in FIG. 6.

FIG. 8 is an illustration of a partial front view of a pair of eyeglasses and the eyeglass docking station removably clipping onto a frame of the eyeglasses.

FIG. 9 is a top view of the eyeglass docking station and wearable display, illustrating polarity configuration of magnets.

FIG. 10 is a left-side perspective view of full assembly of the wearable display device, and the docking station attached to a pair of any type of eyeglasses 26.

FIG. 11 is a right-side perspective view of the full assembly in FIG. 10.

FIGS. 12A-12C are illustrations of a right-side view of the wearable display device docked onto the docking station explaining the various positions in which the wearable display device may be placed.

FIG. 12A is a right-side view of the wearable display device docked onto the docking station with wearable display device in the leveled position.

FIG. 12B is a right-side view of the wearable display device docked onto the docking station with wearable display device in the “glance-down” position.

FIG. 12C is a right-side view of the wearable display device docked onto the docking station with wearable display device in the “glance-up” position.

FIG. 13 is a top view of the wearable display device attached to the docking station.

FIG. 14 is a cross section of pivot point extrusion on wearable display device inside circular pocket on docking station.

FIGS. 15-18 show a second embodiment for the fastener of the eyeglass docking station.

### DETAILED DESCRIPTION

The exemplary embodiment relates to eyeglass docking station for a wearable display device. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

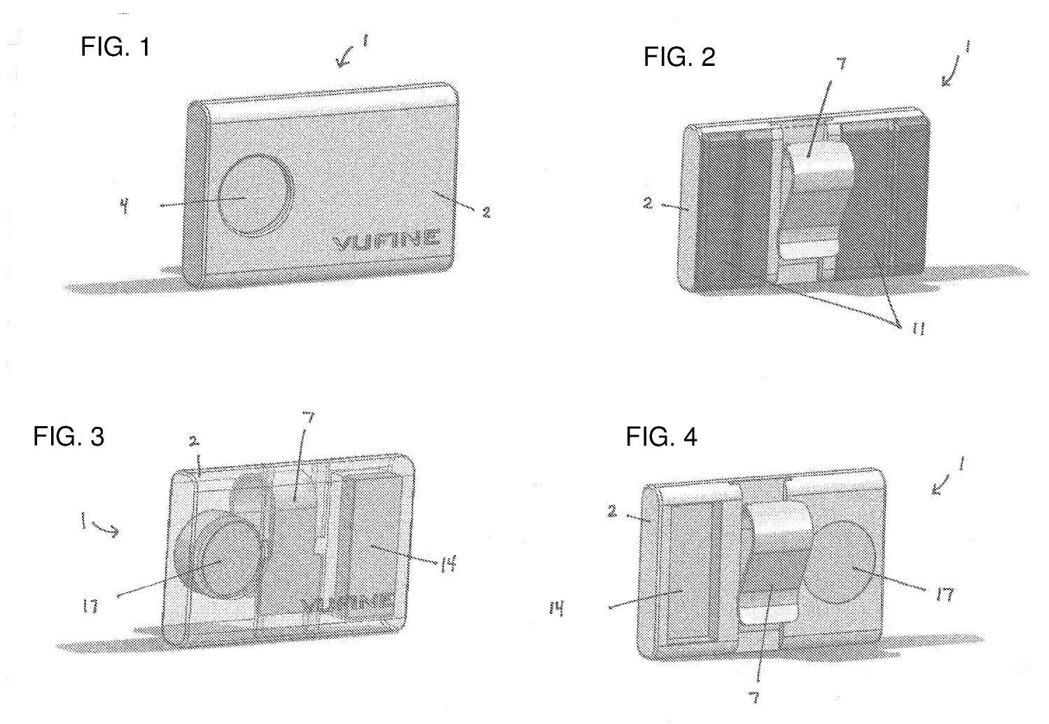

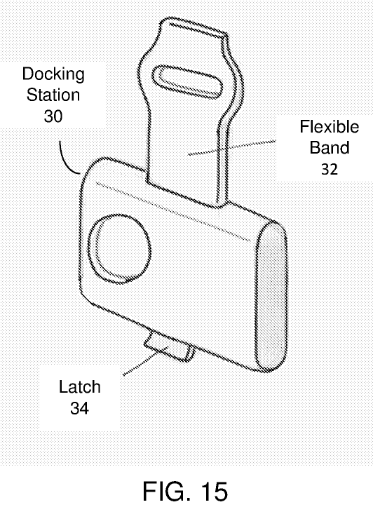

The exemplary embodiments provide an eyeglass docking station for a wearable display device. One embodiment for the eyeglass docking station is illustrated in FIGS. 1-14. A second embodiment is illustrated in FIGS. 15-18B. In both embodiments, the eyeglass docking station is designed to act as a ‘docking station’ that removably receives the wearable display device and connects the wearable display device to any type of eyeglasses. The term eyeglasses as used herein refers to a device having zero, one or more lenses set in a frame that includes a nosepiece and at least one arm piece extending over or around a user's ear(s) or wrapping around the user's head.

In both the first and second embodiments, the docking station 1 comprises a docking station body having a plurality of sides, wherein a first side includes a pocket formed in the docking station body that receives the wearable display device, and a second side includes a fastener that attaches the docking station to a frame of the eyeglasses.

As shown in FIGS. 1 and 2, according to the first embodiment, the docking station 1 comprises a docking station body 2 that includes a plurality of sides, such as for example, front and back sides. FIG. 1, which is a front perspective view of the eyeglass docking station, shows that one side, e.g., the front side, includes a circular pocket 4 formed in the docking station body 2. Although in a preferred embodiment the pocket 4 is circular, in other embodiments, the pocket 4 may comprise any shape, such as any other conic section, e.g., oval, ellipse etc. In yet another embodiment, the pocket 4 may comprise a polygonal shape, e.g., triangular, rectangular, square etc.

FIG. 2, which is a back perspective view of the eyeglass docking station, shows that the other side, e.g., the backside, includes the fastener, which in this embodiment comprises a spring clip 7 and an optional backing 11. In one embodiment, the spring clip 7 slides over an arm piece of the eyeglasses and grips the inserted arm piece. The spring clip 7 may be made of a folded one-piece, semi-flexible material, such as metal, alloy, or plastic. The backing 11 may comprise foam or other suitable covering material.

FIG. 4 is a back perspective view showing the back of docking station body with the backing 11 removed. In one embodiment, the docking station body 2 further includes a docking positioning magnet 14 and a docking pivot magnet 17 housed within the docking station body 2. In one specific embodiment, the docking position magnet 14 may be rectangular in shape and the docking pivot magnet 17 may be circular in shape.

FIG. 3 is a transparent front perspective view of the eyeglass docking station illustrating that in one embodiment, the docking pivot magnet 17 is positioned coaxial with the circular pocket 4 formed on the other side of the docking station body 2, while the docking positioning magnet 14 is positioned vertically within the docking station body 2.

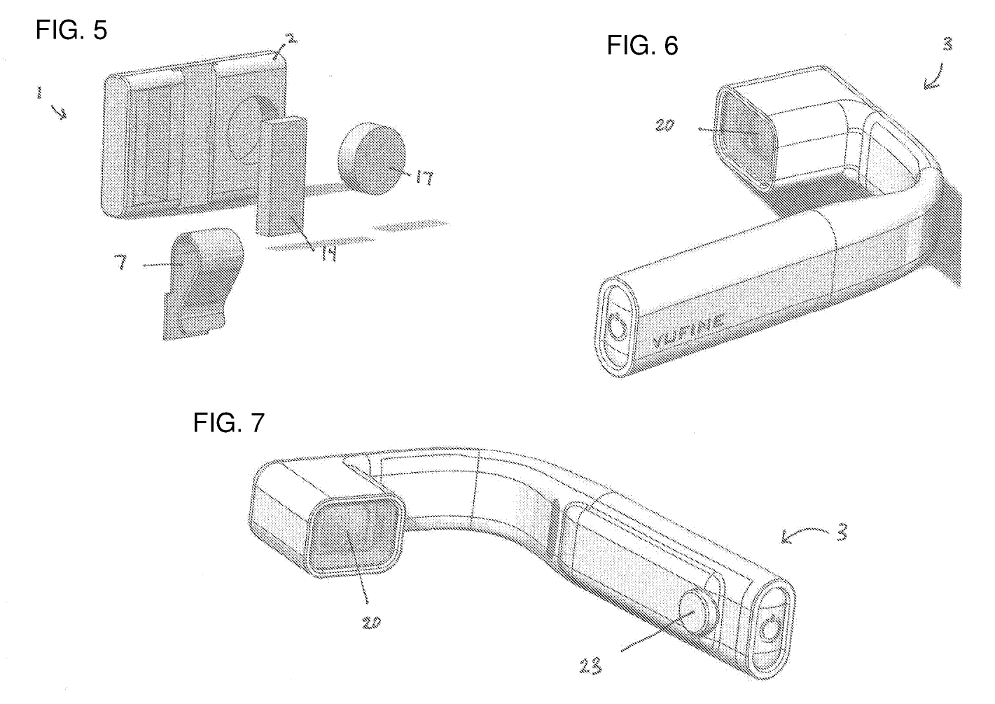

FIG. 5 is an exploded view of the eyeglass docking station showing the spring clip 7, the docking positioning magnet 14 and the docking pivot magnet 17 outside of the docking station body 2, revealing the respective recesses in the docking station body 2 in which the components reside.

Exemplary embodiments for a wearable display device 3 that may attach to the eyeglass docking station are illustrated in FIGS. 6 and 7. FIG. 6 is a right-side perspective view of a wearable display device 3; and FIG. 7 is a left-side perspective view of the wearable display device 3. In one embodiment, the wearable device 3 may comprise a heads-up display (HUD) device, which may include a high-resolution display 20, and a body housing an electronic circuit board and a battery (not shown). In one embodiment, the body of the wearable display device 3 may comprise plastic and/or metal. The wearable display device 3 may connect to an HDMI source via a cable. This HDMI source could be any electronic output device including a smartphone, a GoPro-type camera, a tablet, a computer, and the like. The signal received through the HDMI port from the HDMI source is displayed on the display, which essentially acts as a mini monitor that attaches via the eyeglass docking station to eyeglasses worn by the user.

According to one embodiment, the body of the wearable display device 3 also includes a magnetized circular extrusion 23 formed in the plastic/metal body of the wearable display device 3.

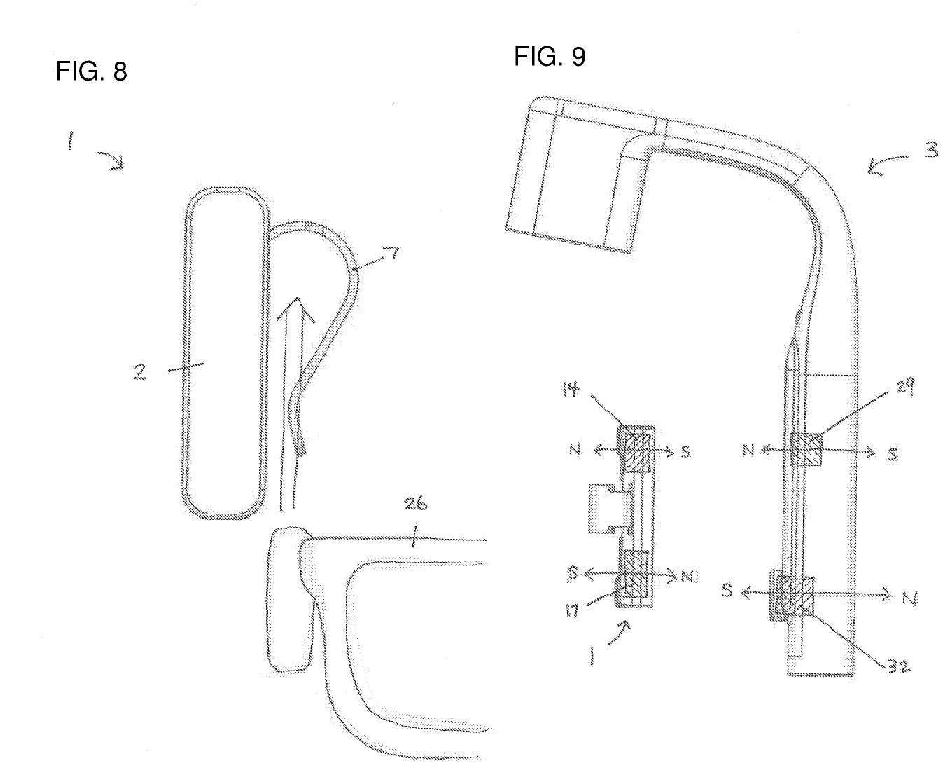

FIG. 8 is an illustration of a partial front view of a pair of eyeglasses and the eyeglass docking station removably clipping onto a frame of the eyeglasses. In operation, the eyeglass docking station 1 is first removably attached to an arm piece of the eyeglasses by placing the spring clip 7 over and onto the arm piece. The eyeglass docking station 1 may be removed by pulling the eyeglass docking station off of the arm piece, as shown in FIG. 8.

FIG. 9 is a top view of the eyeglass docking station and wearable display, illustrating positioning and polarity configuration of the magnets in the docking station 1 and the body of the wearable display device 3. According to the exemplary embodiment, the body of the wearable display device 3 houses a small device pivoting magnet 32 coaxially located behind the circular extrusion 23 on the wearable display device 3. The circular extrusion 23 and the device pivoting magnet 32 are located on the wearable display device 3 so that they are coaxially aligned with the pivot magnet 17 on the docking station 1. The polarities of the circle magnet 32 and the pivot magnet 17 are opposite so that they attract to one another.

A device positioning magnet 29 is located inside the wearable display device 3 positioned opposite of the docking positioning magnet 14 in the docking station body 2. The polarities of these magnets are also opposite such that the magnet 29 and the docking positioning magnet 14 attract one another. By configuring the two sets of magnets as described above, incorrect attachment is avoided since the device pivoting magnet 32 cannot attach to the docking positional magnet 29 and vice versa.

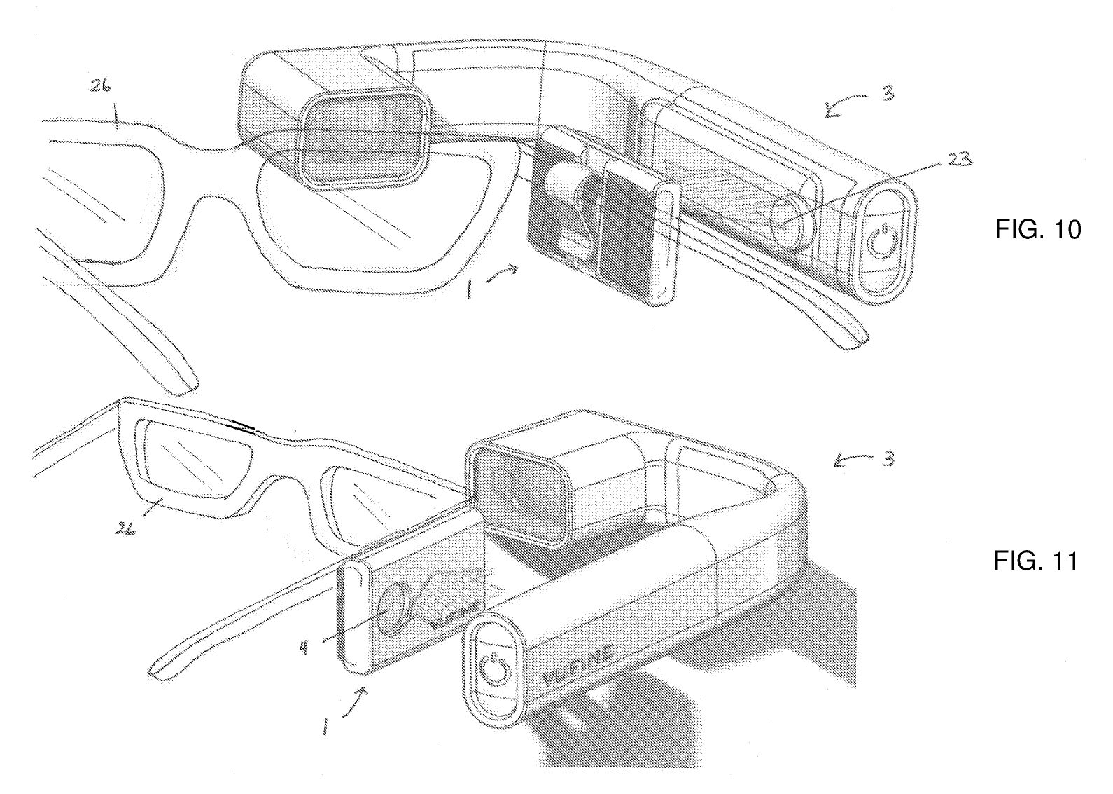

FIG. 10 is a left-side perspective view of full assembly of the wearable display device 3, and the docking station 1 attached to a pair of any type of eyeglasses 26. FIG. 11 is a right-side perspective view of the full assembly of FIG. 10. As shown, when the magnetized circular extrusion 23 on the wearable display device 3 is placed in close proximity to the circular pocket 4 on the docking station 1, the docking pivot magnet 17 and the device pivoting magnet 32 magnetically attract to each other and align the circular extrusion 23 to removably attach within inside the circular pocket 4. Similarly, device positioning magnet 29 in the wearable display device 3 and the docking positioning magnet 14 in the docking station body 2 magnetically attract to each other.

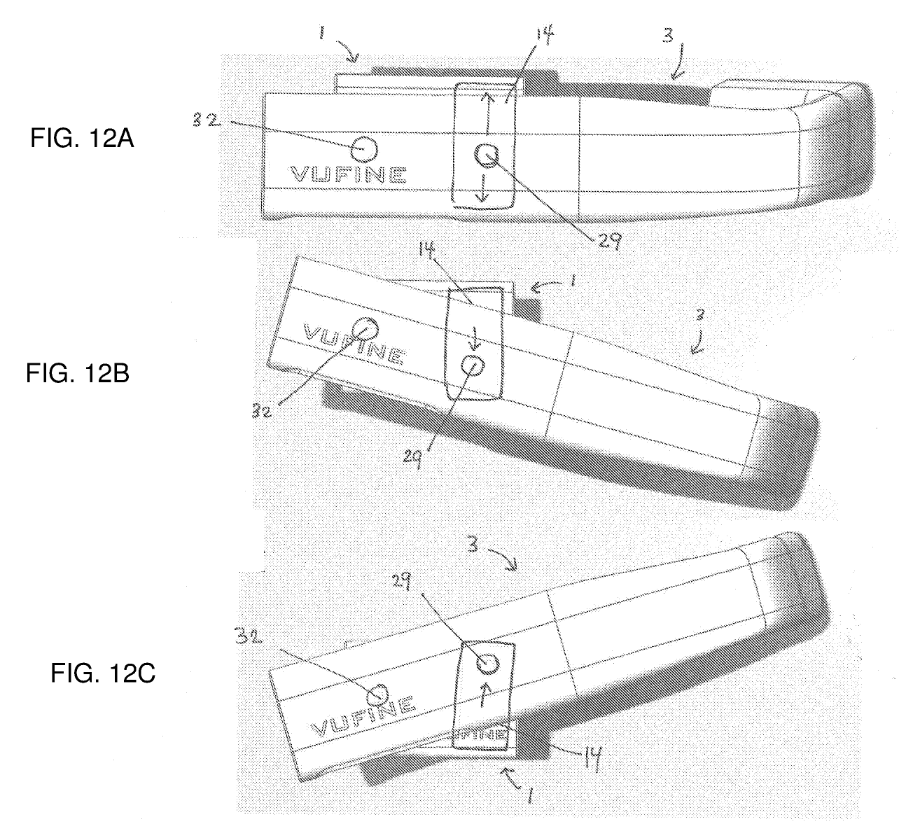

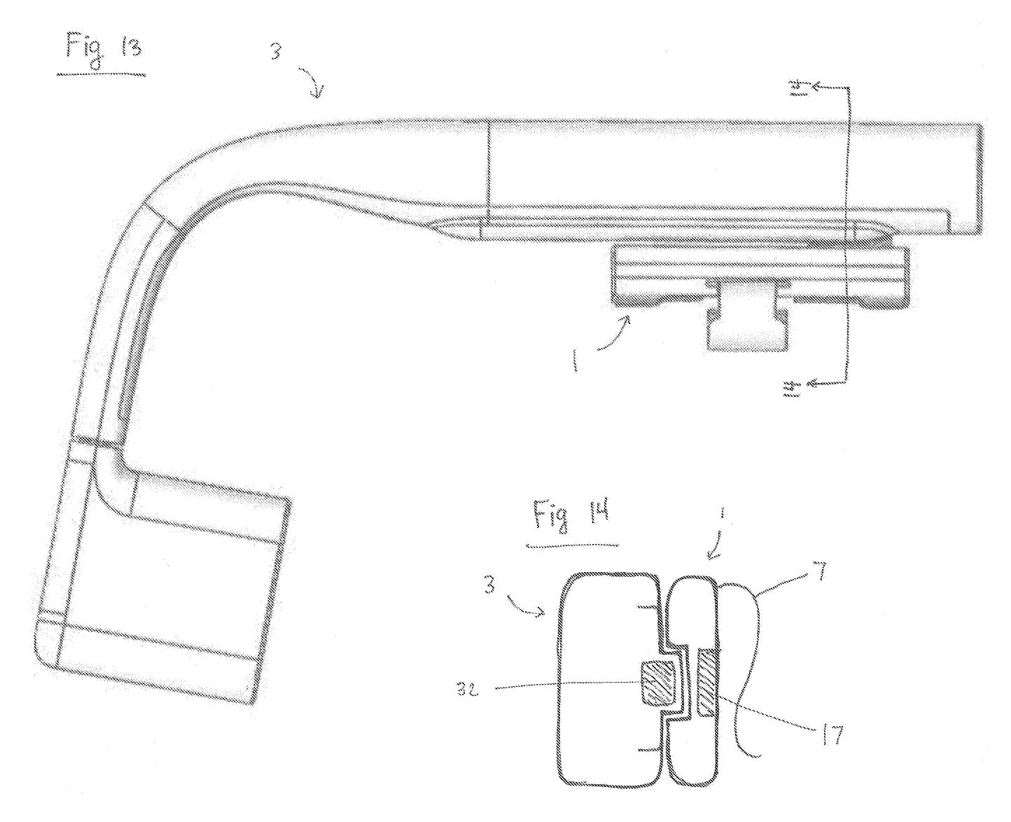

Attraction between the two pairs of magnets (17, 32) and (14, 29) enables a firmer attachment of the wearable display device 3 onto the docking station 1 to help prevent tugging from a connected wire and function as a pivot point that allows the user to adjust the viewing angle of the wearable display device 3 in the user's field of vision, as shown in FIGS. 12A-12C.

FIGS. 12A-12C are diagrams illustrating a right-side view of the wearable display device docked onto the docking station 1 and the various positions in which the wearable display device 3 may be placed with respect to the user's eye level. Because the device pivoting magnet 29 and the wearable display device 3 is axially magnetized through its center to the docking positioning magnet 14 on the docking station 1, the wearable display device 3 may be swiveled around the pivot point at the circular pocket 4. This allows a display 20 to be positioned at various viewing angles with respect to user's eye level. The pivot is placed at the theoretical center of the eye orbit.

FIG. 12A is a right-side view of the wearable display device docked onto the docking station showing the wearable display device in a leveled position, i.e., the display device 20 is center with the user's eye. FIG. 12B is a right-side view of the wearable display device docked onto the docking station showing the wearable display device in a “glance-down” position, i.e., the display device 20 is below the center of the user's eye. FIG. 12C is a right-side view of the wearable display device docked onto the docking station showing the wearable display device in the “glance-up” position, i.e., the display device 20 is above the center of the user's eye.

FIG. 13 is a top view of the wearable display device 3 attached to the eyeglass docking station 1. And FIG. 14 is a cross section along section line 14 showing the pivot point extrusion on wearable display device 3 inside circular pocket 4 on eyeglass docking station 1, where magnets 32 and 17 attract one another.

FIGS. 15-18 show a second embodiment for the fastener of the eyeglass docking station. In this embodiment, the fastener for the docking station 30 comprises a flexible band 32 protruding from one of the sides, e.g. the top side, of the docking station body. In one embodiment, the flexible band 32 includes an opening in a portion of the flexible band 32 farthest away from the docking station 30. The docking station 30 further includes a latch 34 that protrudes from another side, e.g., the bottom side, of the docking station body. In one embodiment, the flex band 32 may comprise various types of flexible materials.

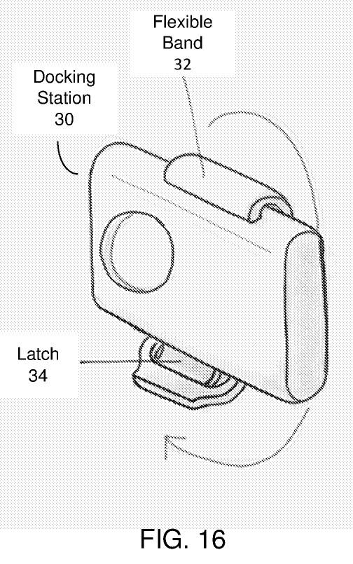

FIG. 16 is a diagram showing that to place the flexible band 32 into a closed position, the flexible band 32 may be pulled down a backside of the docking station body and around the latch 34 so that the opening in the flexible band 32 may latch onto the latch 34 to place and hold the flexible band 32 in a firmly closed position. The length and materials of the flexible band 32 may be selected to affect how tightly the flexible band 32 is held in place against the docking station body.

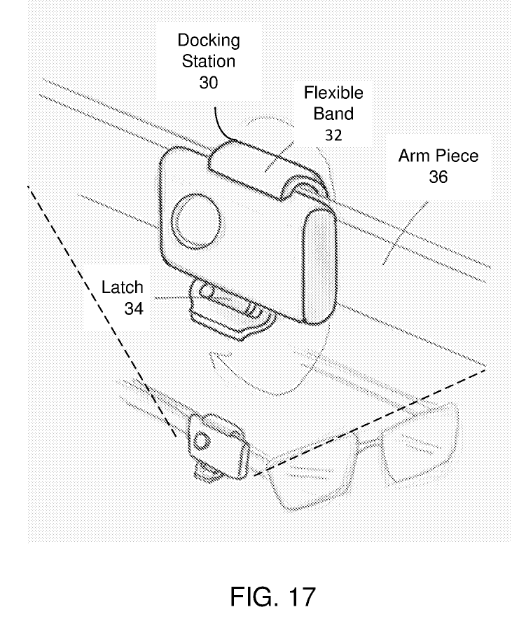

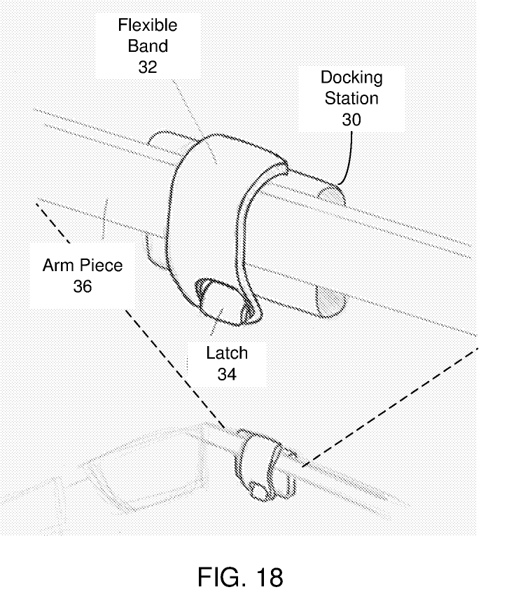

FIG. 17 is a diagram and an enlarged view of the flexible band 32 in a closed position around an arm piece of the eyeglasses. And FIG. 18 is a diagram and an enlarged view of a backside view of the docking station 30 and the flexible band 32 in a closed position around the arm piece 36. The flexible band 32 is shown wrapped around the arm piece 36 and latched onto the latch 34 to firmly hold the docking station 30 to the arm piece 36 and the body of the docking station. This flexible band embodiment allows a user to position the docking station 30 anywhere along the length of the arm piece 36 as long as a firm hold is possible.

A method and system for eyeglass docking station for a wearable display device has been disclosed. The present invention has been described in accordance with the embodiments shown, and there could be variations to the embodiments, and any variations would be within the spirit and scope of the present invention. Accordingly, many modifications may be made by one of ordinary skill in the art without departing from the spirit and scope of the appended claims.

We claim:

1. An eyeglass docking station, comprising:
a docking station body having a plurality of sides, wherein a first side includes a pocket formed in the docking station body, and a second side includes a fastener that attaches the docking station to a frame of the eyeglasses; and
a docking pivot magnet housed within the docking station body positioned coaxial with the circular pocket, the circular pocket removably receiving a magnetized extrusion of a wearable display device to attach the wearable display device to the docking station body and to form a pivot point that allows a user to adjust a viewing angle of the wearable display device.

2. The eyeglass docking station of claim 1, wherein the fastener comprises a spring clip that slides over the frame of the eyeglasses and grips the arm piece.

3. The eyeglass docking station of claim 2, wherein the spring clip comprises a folded, one-piece, semi-flexible material.

4. The eyeglass docking station of claim 1, wherein the fastener comprises:
a flexible band protruding from one of the sides of the docking station body, wherein the flexible band includes an opening and a portion of the flexible band farthest away from the docking station; and
a latch that protrudes from another side of the docking station body.

5. The eyeglass docking station of claim 4, wherein the flexible band is placed into a closed position around the frame of the eyeglasses by pulling down the flexible band around a backside of the docking station body and around the latch so that the opening in the flexible band latches onto the latch to hold the flexible band in a closed position.

6. The eyeglass docking station of claim 1, wherein the docking station body further includes a docking positioning magnet positioned vertically within the docking station body.

7. The eyeglass docking station of claim 6, wherein the docking positioning magnet is positioned opposite to a device positioning magnet located inside the wearable display device.

8. The eyeglass docking station of claim 7, wherein when the magnetized circular extrusion on the wearable display device is placed in close proximity to the circular pocket on the docking station, the docking pivot magnet and the device pivoting magnet magnetically attract to each other and align the circular extrusion to removably attach within inside the circular pocket.

9. The eyeglass docking station of claim 6, wherein the docking station body further includes respective recesses that receive the spring clip, the docking position magnet and the docking pivot magnet.

10. The eyeglass docking station of claim 1, wherein the pocket comprises a conic section shape.

11. The eyeglass docking station of claim 10, wherein the pocket comprises a circular pocket.

12. The eyeglass docking station of claim 1, wherein the pocket comprises a polygonal shape.
